(19) United States
(12) Patent Application Publication
(10) Pub. No.: US 2021/0362707 A1
(43) Pub. Date: Nov. 25, 2021

(54) PREDICTION OF A LIKELY DRIVING BEHAVIOR

(71) Applicant: Robert Bosch GmbH, Stuttgart (DE)

(72) Inventors: Jan-Hendrik Pauls, Grossbottwar (DE); Tobias Strauss, Obersulm (DE)

(21) Appl. No.: 17/291,175

(22) PCT Filed: Sep. 16, 2019
(86) PCT No.: PCT/EP2019/074652

§ 371 Date: May 4, 2021

(30) Foreign Application Priority Data
Nov. 6, 2018 (DE) 10 2018 218 922.6

(51) Int. Cl. B60W 30/095; B60W 40/04; B60W 50/00; G06K 9/00; G06N 20/00

(52) U.S. Cl. CPC B60W 30/0956; B60W 40/04; B60W 50/0097; G06K 9/00825; G06K 2209/23; B60W 2540/049; B60W 2554/4046; B60W 2556/45; G06K 2209/15; G06N 20/00

(57) ABSTRACT

A method for carrying out a prediction of a driving behavior of a second vehicle by a control unit of a first vehicle. Data of vehicle surroundings of the second vehicle, and/or data of a vehicle driver and/or of a load of the second vehicle being received by the control unit, at least one feature being ascertained based on the data and a likely driving behavior of the second vehicle being calculated by the control unit based on the ascertained feature. A control unit is also described.

### FIELD

The present invention relates to a method for carrying out a prediction of a driving behavior of a second vehicle via a control unit and to a control unit for coupling with at least one sensor and for evaluating measured data of the at least one sensor.

### BACKGROUND INFORMATION

Conventional vehicles operable in an automated manner such as, for example, highly automated or fully automated vehicles, include a vehicle sensor system, which is used to detect surroundings. In addition to static obstacles and the roadway, the surroundings include dynamic objects and, in particular, other road users.

To enable a reliable and anticipatory operation of such a vehicle, the previous behavior of road users in combination with the outward appearance of the road user is used to predict a likely behavior of the road user. The likely behavior of road users may, in particular, be used to initiate an interaction or a cooperation with the corresponding road users.

### SUMMARY

An object of the present invention is to provide a method by which a likely behavior of road users may be reliably and dynamically ascertained.

This object may be achieved with the aid of example embodiments of the present invention. Advantageous embodiments of the present invention are described herein.

According to one aspect of the present invention, a method is provided for carrying out a prediction of a driving behavior of a second vehicle via a control unit of a first vehicle.

A likely driving behavior of at least one second vehicle and/or of a vehicle driver of the second vehicle, in particular, may be calculated by the control unit of the first vehicle.

In accordance with an example embodiment of the present invention, data of vehicle surroundings of the second vehicle and/or data of a vehicle driver and/or a load of the second vehicle are received by the control unit.

The data may be detected, in particular, by at least one sensor and transferred to the control unit. Alternatively or in addition, measured data of the vehicle surroundings may be received by the control unit from a database. The measured data of the second vehicle, of a vehicle driver and/or of a load of the second vehicle may be ascertained by at least one onboard sensor of the first vehicle and transferred to the control unit.

Based on the data, at least one feature is ascertained and a likely driving behavior of the second vehicle is calculated by the control unit based on the ascertained feature.

At least one feature of the vehicle surroundings, of the second vehicle, of the vehicle driver of the second vehicle, of the passengers and/or of the load of the second vehicle, in particular, may be ascertained by the control unit of the first vehicle. According to one specific embodiment of the present invention, the data in this case may be measured data, which are received by at least one sensor of the first vehicle and/or pieces of information or data from at least one database.

According to one further aspect of the present invention, a control unit is provided, which is configured to carry out the method. The control unit is, in particular, couplable to at least one sensor and/or to at least one database.

The demands placed on the detection of the vehicles are growing due to increasing development in the field of autonomous or semi-autonomous vehicles.

With the aid of the method, it is possible to obtain semantic indications and/or holistic knowledge about the vehicle surroundings and the vehicles. For this purpose, the method may be carried out by a control unit. The control unit may, for example, be situated on-board or off-board the vehicle. The control unit may, in particular, be mounted in the first vehicle or in further vehicles and be connected to the vehicle sensor system.

Alternatively or in addition, infrastructure units such as, for example traffic monitoring units, may also be equipped with such a control unit. In this case, the infrastructure sensors may be connected to the control unit in a data-transmitting manner and, for example, may be used for the predictive evaluation of traffic movements.

The method may thus be used to gain an understanding of a setting, which is ascertained based on features of the vehicle surroundings observed by the sensors. Here, the area recorded by the sensors is viewed preferably holistically. As many features as possible are extracted from the measured data and further processed.

The further processing of the features by the control unit may be used, for example, for limiting operating possibilities of the observed vehicles such as, for example, of the at least one second vehicle. Thus, a likely trajectory or likely driving dynamics, for example, during braking actions or lane changes, may be determined with greater probability.

The likely driving behavior of the at least one second vehicle ascertainable by the control unit may, for example, include likely vehicle dynamics, a likely driving mode, and a likely trajectory and the like.

Based on the likely driving behavior of the second vehicle and/or of the vehicle driver of the second vehicle, the control unit is able to direct the corresponding data about the likely driving behavior to a vehicle control system of the first vehicle. Thus, it is possible to control the first vehicle adapted to the likely behavior, as a result of which critical situations are avoidable. For example, the first vehicle may set a greater safety distance or respond differently to braking maneuvers of preceding vehicles, for example, by changing lanes. In addition, a passing maneuver by the first vehicle may be delayed if the preceding vehicle in high probability will take an exit and thus unblock the present roadway.

The corresponding control commands may alternatively also be generated directly by the control unit and transmitted to the vehicle control system.

The measured data of the vehicle surroundings of the second vehicle may include, in particular, pieces of local or temporal information, which are relevant as related to the traffic.

Many of the semantic indications may be ascertained, in particular, with knowledge of the time of day, of the other temporal, local and semantic surroundings conditions.

For example, the pieces of information or measured data may include vacation times, usual times for evening rush hour, events, fairs and the like.

In addition, map data, for example, relating to possible trajectories, so-called “points of interest,” pieces of information about urban areas, taxi stands, bus stops, business addresses and the like, may be stored as measured data of the vehicle surroundings.

The measured data of the vehicle surroundings may be directly ascertained by the vehicle sensor system of the first vehicle or may be drawn from one or from multiple databases by the control unit of the first vehicle.

The database may be an internal database of the first vehicle and/or of the control unit or an off-board database. In the event of an external database, the control unit may establish a wireless communication link to the off-board database and access the locally and temporally relevant data.

The vehicle driver of the at least one second vehicle and/or of the first vehicle may be a person, in particular, in the case of manually controlled or semiautonomous vehicles, and a vehicle control system in the case of highly automated or fully automated or driverless vehicles.

The at least one sensor may be one or multiple cameras, a LIDAR sensor, a radar sensor, an infrared sensor, a thermal imaging camera and the like.

The features may be detected by the control unit of the first vehicle if, for example, a relevant connection to the possible driving behavior of the second vehicle is established in the received measured data. This may take place, for example, based on static or dynamic factors or conditions.

A plurality of features for an optimized prediction of a behavior of road users may be collected and used by this method.

An evaluation of mutual dependencies of a plurality of features of other road users in the form of a holistic understanding of the setting may, in particular, be carried out by the control unit of the first vehicle.

According to one exemplary embodiment of the present invention, the likely driving behavior of the second vehicle is calculated by a simulation model, by at least one algorithm and/or by an artificial intelligence. In this way, the driving behavior may be flexibly ascertained by static or dynamic systems.

If the complexity of possibilities of the features exceeds the computing or modelling capabilities used in the control unit, indications or features may be integrated as side conditions into machine learning methods. In this case, the relevant calculation may alternatively or additionally be carried out off-board the vehicle.

By using artificial intelligence or machine learning, a comprehensive understanding of the surroundings and, in particular, an understanding of the setting of the road users and their role therein may be ascertained by the control unit of the first vehicle.

According to one further specific embodiment of the present invention, an age, a gender and/or a condition of the vehicle driver may be ascertained as a feature by the control unit of the first vehicle. Based on such features of the vehicle driver, a likely driving mode may be assessed by the control unit. Within the scope of probabilities, for example, a more moderated driving mode may be expected in the case of an older driver than in the case of a young driver. In addition, it may be checked via the vehicle sensor system or infrastructure sensors whether the vehicle driver is tired and thus reacts sluggishly to unexpected situations.

According to one further specific embodiment of the present invention, a vehicle class, a vehicle condition, at least one vehicle license plate number and/or a condition of a rotating beacon may be ascertained by the control unit of the first vehicle. Based on the features of the vehicle, a likely trajectory of the second vehicle may, in particular, be estimated or calculated by the control unit of the first vehicle.

For example, a vehicle will most likely drive in the direction of the country of registration or of the district of registration in accordance with the ascertained license plate number. If temporal features such as vacation times are used, then holiday trips may also be taken into consideration. Thus, it may be calculated, in particular, at intersections or exits which lane or exit will most likely be used by the second vehicle.

In addition, the vehicle category and, in particular, the vehicle price may offer indications about the part of the city into which a vehicle will drive.

The rotating beacons of fire department vehicles, police vehicles and ambulances may also provide information about whether the respective vehicle is departing a station or a hospital. For example, a light in the box body of an ambulance may provide the piece of information that the ambulance has taken a patient and is probably driving to the hospital.

According to one further exemplary embodiment of the present invention, an advertising space and/or a label on the second vehicle is/are ascertained as a feature by the control unit of the first vehicle and from which a driving behavior of the second vehicle is assessed.

Labels and signals such as, for example, a taxi of a defined part of the city, may also be utilized by the control unit to calculate a likely driving direction. For example, the taxi will drive in an occupied state away from the part of the city and return to the part of the city in an empty state.

According to one further exemplary embodiment of the present invention, a likely trajectory of the second vehicle is calculated by the control unit of the first vehicle based on the ascertained feature. In this way, the features of the vehicle and, in particular, the external features such as license plate number and labels, may be used by the control unit to predict the likely trajectory.

According to one further exemplary embodiment of the present invention, a likely driving mode of the second vehicle is ascertained by the control unit of the first vehicle based on the at least one ascertained feature of the vehicle driver. Thus, a particularly dynamic driving behavior or a sluggish driving behavior may be expected. Likely delayed reactions, for example, as a result of fatigue, may, in particular, also be detected by the control unit and an adaptation of the driving mode of the first vehicle may be carried out.

According to one further exemplary embodiment of the present invention, a load condition of the second vehicle is ascertained by the control unit of the first vehicle, likely vehicle dynamics of the second vehicle being calculated by the control unit based on the load condition of the second vehicle. As a result, it is possible to obtain indications about a driving direction or driving dynamics of the second vehicle. For example, a vehicle packed with suitcases at the start of the vacation will probably drive away from the district of registration of the vehicle.

According to one further specific embodiment of the present invention, likely vehicle dynamics of the second vehicle are calculated by the control unit of the first vehicle based on a number of passengers of the second vehicle. The load condition of the vehicle may thus be utilized to provide information about its vehicle dynamic properties. A fully loaded vehicle, for example, is less able to quickly react to situations than an empty vehicle. Thus, a likely braking distance of the second vehicle may, in particular, be assessed by the control unit of the first vehicle.

The at least one second vehicle may be situated in the surroundings of the first vehicle visible to sensors. The second vehicle may, in particular, drive in front of the first vehicle or offset from the first vehicle.

All ascertained features may be preferably considered in combination or individually by the control unit when calculating the likely driving behavior.

### BRIEF DESCRIPTION OF THE DRAWINGS

Preferred exemplary embodiments of the present invention are explained in greater detail below based on highly simplified schematic representations.

FIG. 1 schematically shows a representation of a system including vehicles and an infrastructure unit, in accordance with an example embodiment of the present invention.

FIG. 2 schematically shows a flowchart for illustrating a method according to one specific embodiment of the present invention.

### DETAILED DESCRIPTION OF EXAMPLE EMBODIMENTS

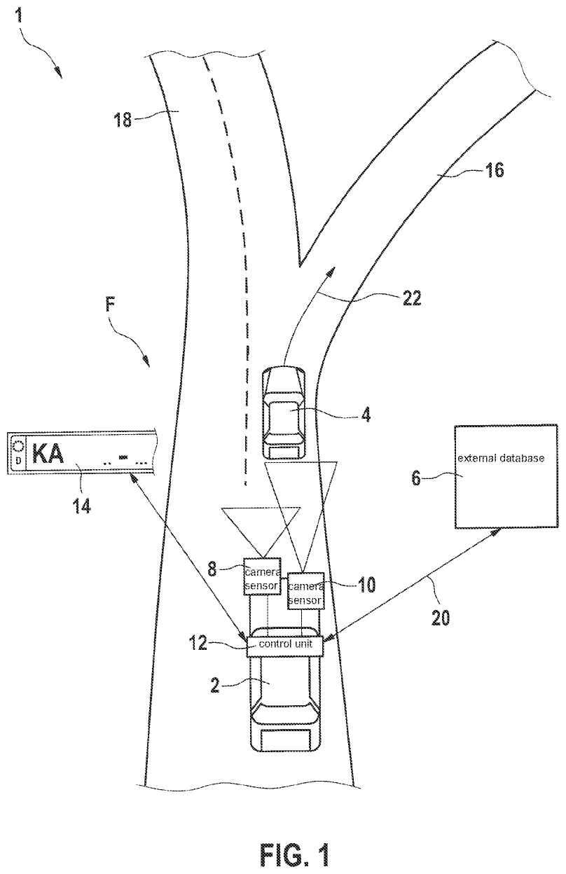

FIG. 1 schematically shows a representation of a system 1, including a first vehicle 2, a second vehicle 4 and an external database 6. First vehicle 2 is driving behind second vehicle 4.

First vehicle 2 includes two sensors 8, 10, which are designed as cameras. Camera sensors 8, 10 are connected in a data-transmitting manner to an onboard control unit 12. Control unit 12 is able to receive and evaluate the measured data of sensors 8, 10. For this purpose, control unit 12 includes an artificial intelligence, which has been trained in advance. The detection ranges of sensors 8, 10 are schematically represented.

Sensors 8, 10 of first vehicle 2 detect second vehicle 4. Based on the measured data of sensors 8, 10, control unit 12 is able to ascertain or detect features of second vehicle 4. According to the exemplary embodiment, a license plate number 14 of second vehicle 4, for example, is detected and a registration district “KA” for Karlsruhe of second vehicle 4 is ascertained by control unit 12.

Based on license plate number 14, control unit 12 is able to calculate the likely behavior of second vehicle 4 to the extent that second vehicle 4 will with an increased probability take an exit 16 in the direction of Karslruhe and not follow the course of present road 18.

Control unit 12 of first vehicle 2 is able to draw data from database 6 via a wireless communication link 20. Database 6 may include, in particular, pieces of local and temporal information, which are useful for likely trajectory 22. According to the exemplary embodiment, control unit 12 is able to receive pieces of information about the road courses and the route to Karlsruhe via exit 16. Thus, the likely trajectory may be calculated as a likely driving behavior of second vehicle 4 by the control unit with the aid of the artificial intelligence.

Without the use of semantic knowledge, the probability of traveling on exit 16 is approximately 50:50 or only a fixed a priori probability may be assumed. With knowledge about other road user 4 and knowledge about the surroundings, this a priori probability may be determined for each road user 4 individually and the prediction may thus be improved.

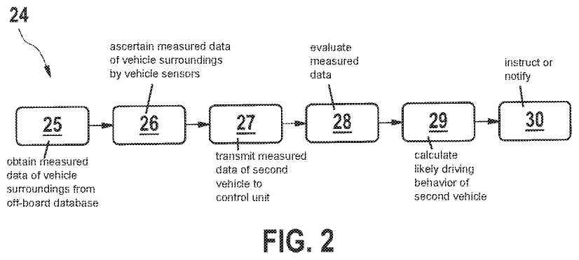

FIG. 2 schematically shows a flowchart for illustrating a method 24 according to one specific embodiment of the present invention.

In a step 25, measured data of vehicle surroundings F are obtained by control unit 12 from off-board database 6.

Alternatively or in addition, measured data of vehicle surroundings F may be ascertained 26 by vehicle sensors 8, 10.

Measured data of second vehicle 4, of a vehicle driver and/or of a load of second vehicle 4 is/are ascertained by vehicle sensors 8, 10 of first vehicle 2 and transmitted 27 to control unit 12 subsequent to or in parallel with preceding steps 25, 26.

The measured data are evaluated by control unit 12 in a further step 28 and features 14 are detected or ascertained.

At least one feature 14 of vehicle surroundings F, of second vehicle 4, of the vehicle driver of second vehicle 4, of the passengers and/or of the load of second vehicle 4, in particular, is/are ascertained by control unit 12 of first vehicle 2 based on the measured data.

In a further step 29, a likely driving behavior 22 of second vehicle 4 is calculated by control unit 12 of first vehicle 2 based on the ascertained features.

An instruction or a notification of a vehicle control system of first vehicle 2 may subsequently take place via control unit 12, as a result (30) of which the driving mode of first vehicle 2 may be adjusted in accordance with likely driving behavior 22 of second vehicle 4.

1-11. (canceled)

12. A method for carrying out a prediction of a driving behavior of a second vehicle by a control unit of a first vehicle, the method comprising the following steps:
receiving, by the control unit of the first vehicle, data of: (i) vehicle surroundings of the second vehicle, and/or (ii) a vehicle driver of the second vehicle and/or (iii) a load of the second vehicle;
ascertaining, by the control unit, at least one feature based on the data; and
calculating, by the control unit, a likely driving behavior of the second vehicle based on the ascertained feature.

13. The method as recited in claim 12, wherein the data are received from a database and/or from a sensor of the first vehicle.

14. The method as recited in claim 12, wherein the likely driving behavior of the second vehicle is calculated by a simulation model, and/or by at least one algorithm and/or by an artificial intelligence.

15. The method as recited in claim 12, wherein the at least one feature ascertained by the control unit includes an age of the vehicle driver, and/or a gender of the vehicle driver, and/or a condition of the vehicle driver.

16. The method as recited in claim 12, wherein the at least one feature ascertained by the control unit includes a vehicle class, and/or a vehicle condition, and/or at least one vehicle license plate number and/or a condition of a rotating beacon.

17. The method as recited in claim 12, wherein the at least one feature ascertained by the control unit includes an advertising space on the second vehicle and/or a label on the second vehicle, the driving behavior of the second vehicle being assessed based on the advertising space on the second vehicle and/or the label on the second vehicle.

18. The method as recited in claim 12, wherein a likely trajectory of the second vehicle is calculated by the control unit of the first vehicle based on the ascertained feature.

19. The method as recited in claim 12, wherein a likely driving mode of the second vehicle is ascertained by the control unit of the first vehicle based on the at least one ascertained feature of the vehicle driver of the second vehicle.

20. The method as recited in claim 12, wherein a load condition of the second vehicle is ascertained by the control unit of the first vehicle based on the received measured data, and likely vehicle dynamics of the second vehicle are calculated by the control unit of the first vehicle based on the load condition of the second vehicle.

21. The method as recited in claim 12, wherein likely vehicle dynamics of the second vehicle are calculated by the control unit of the first vehicle based on a number of passengers of the second vehicle.

22. A control unit of a first vehicle configured to carry out a prediction of a driving behavior of a second vehicle, the control unit configured to:
receive, by the control unit of the first vehicle, data of: (i) vehicle surroundings of the second vehicle, and/or (ii) a vehicle driver of the second vehicle and/or (iii) a load of the second vehicle;
ascertain, by the control unit, at least one feature based on the data; and
calculate, by the control unit, a likely driving behavior of the second vehicle based on the ascertained feature.
